(19) United States
(12) Patent Application Publication
(10) Pub. No.: US 2006/0120769 A1
(43) Pub. Date: Jun. 8, 2006

(54) Developing cartridge and electrophotographic image forming apparatus having the same

(76) Inventor: Dong-hyuk Choi, Seoul (KR)

Correspondence Address: STANZIONE & KIM, LLP, 919 18TH STREET, N.W., SUITE 440, WASHINGTON, DC, 20006, US

(21) Appl. No.: 11/224,238

(22) Filed: Sep. 13, 2005

(30) Foreign Application Priority Data
Dec. 4, 2004 (KR) 2004-101540

(51) Int. Cl. G03G 15/08

(52) U.S. Cl. 399/283

(57) ABSTRACT

A developing cartridge and an electrophotographic image forming apparatus having the same. The developing cartridge and the electrophotographic image forming apparatus having the same include a feed surface formed on a lower inner wall of a housing of the developing cartridge and inclined in a downward direction toward a storage unit so that developer that is removed from a developing roller and a supplying roller flows toward the storage unit and is collected therein.

### CROSS-REFERENCE TO RELATED APPLICATIONS

This application claims the benefit of Korean Patent Application No. 2004-101540, filed on Dec. 4, 2004, in the Korean Intellectual Property Office, the disclosure of which is incorporated herein in its entirety by reference.

### BACKGROUND OF THE INVENTION

1. Field of the Invention

The present general inventive concept relates to an image forming apparatus, and more particularly, to a developing cartridge and an electrophotographic image forming apparatus having the same.

2. Description of the Related Art

In general, an electrophotographic image forming apparatus forms an electrostatic latent image on a photosensitive body, develops the electrostatic latent image using a powder developer, transfers the developed image onto paper via a predetermined transfer medium, and forms an image. The electrophotographic image forming apparatus includes a developing cartridge containing the developer to develop the electrostatic latent image formed on an outer circumference of a photosensitive body.

FIG. 1 is a partial cross-sectional view illustrating a conventional developing cartridge of an electrophotographic image forming apparatus. Referring to FIG. 1, a main chamber 12, which contains developer (e.g., a toner), is disposed inside a housing 10. A developing roller 20 is installed on a front side of the housing 10. A photosensitive body 25 is installed to contact (or be separated from) the developing roller 20. A supplying roller 30 contacts the developing roller 20 and adheres the toner to the developing roller 20. A guide member 40, which guides the toner supplied from an agitator 14 in the main chamber 12 to the supplying roller 30, is disposed below the supplying roller 30. A recovering roller 50, which returns residual toner that is not adhered to the developing roller 20 to the main chamber 12 in which the agitator 14 is disposed, is disposed below the guide member 40. In addition, a toner layer 42, which prevents the toner from being moved by the agitator 14 to a recovering chamber 51, is formed at one side of the guide member 40.

The supplying roller 30 is rotated in a predetermined direction while cleaning residual toner left on a surface of the developing roller 20 and supplying the toner to the surface of the developing roller 20 by compressing the toner on the cleaned surface of the developing roller 20.

A doctor blade 16, which regulates a thickness of the toner adhered to the surface of the developing roller 20, is disposed in the housing 10 and removes excess toner from the surface of the developing roller 20.

The toner that is removed from the developing roller 20 by the doctor blade 16 and the toner that is not adhered to the surface of the developing roller 20 pass along a toner moving path A to be collected in the recovering chamber 51. The toner that is collected in the recovering chamber 51 is recovered by the recovering roller 50 into the main chamber 12 via a recovering toner moving path B.

A seal bracket 33, which covers the developing roller 20 and the supplying roller 30 to prevent outflow of the toner, is installed at a front upper part of the housing 10. A seal film 34 is attached to one side of the seal bracket 33. The seal film 34 serves to prevent the toner between the developing roller 20 and the supplying roller 30 from flowing out of the housing 10 while preventing a foreign substance from flowing into the housing 10 from an outside of the housing 10.

In the conventional developing cartridge, the recovering roller 50 is used as an apparatus for recovering the residual toner. That is, the toner that is removed from the developing roller 20 by the doctor blade 16, and the toner that is not attached to the surface of the developing roller 20 by the supplying roller 30 is recovered by the recovering roller 50 into the main chamber 12.

Components such as the recovering chamber 51, the recovering roller 50, and the toner layer 42 are used in a toner-recovering method. In addition, another driving source is required for driving the recovering roller 50. As such, an overall structure of the conventional developing cartridge becomes complicated, and it is difficult to minimize a size of the conventional developing cartridge and the image forming apparatus having the same.

In addition, since a driving source (e.g., a motor) for driving the recovering roller 50 of the developing cartridge is required, manufacturing costs inevitably increase.

### SUMMARY OF THE INVENTION

The present general inventive concept provides a developing cartridge which recovers a developer removed from a supplying roller and a developing roller without using an additional recovering member, and an image forming apparatus having the same.

The present general inventive concept also provides a developing cartridge which recovers a developer without using a driving unit to separately drive a recovering member, and an image forming apparatus having the same.

Additional aspects of the present general inventive concept will be set forth in part in the description which follows and, in part, will be obvious from the description, or may be learned by practice of the general inventive concept.

The foregoing and/or other aspects of the present general inventive concept may be achieved by providing a developing cartridge usable with an electrophotographic image forming apparatus, the developing cartridge including a housing, a storage unit installed inside the housing to store a developer, a developing roller to supply the developer to an electrostatic latent image formed on a photosensitive body, and a supplying roller to supply the developer to the developing roller from the storage unit. A feed surface is formed on a lower inner wall of the housing and is inclined in a downward direction toward the storage unit so that the developer removed from the developing roller and the supplying roller flows toward the storage unit and is collected therein.

The developing cartridge may further include a regulating member having a first side being installed on the housing and a second side to regulate a layer of the developer attached to an outer circumference of the developing roller.

A center of the supplying roller may be installed at a higher position than a center of the developing roller. The regulating member may be installed at a lower position than the center of the developing roller so that the developer removed from the developing roller by the regulating member flows toward the feed surface.

The developing cartridge may include a first developer outflow-prevention member installed at the feed surface having a first side to contact a side surface of the regulating member. The first developer outflow-prevention member prevents the developer removed from the developing roller and the supplying roller from flowing out of the housing.

The first developer outflow-prevention member may be a sealing film. The sealing film may be a conductive film.

The developing cartridge may further include a second developer outflow-prevention member installed on the housing having an upper portion to contact a lower portion of the first developer outflow-prevention member and a side surface to contact the regulating member, and the second developer outflow-prevention member prevents the developer removed from the developing roller and the supplying roller from flowing out of the housing.

The second developer outflow-prevention member may be a sealing member.

The regulating member may include a first portion having a first side installed on the housing and a second side to contact the outer circumference of the developing roller along a lengthwise direction thereof to provide a predetermined pressure thereon, and a second portion bent with respect to the first portion at a predetermined angle to extend in a direction of the feed surface to a predetermined length.

The developing cartridge may further include a first developer outflow-prevention member installed at the feed surface having a first side to contact a side surface of the first portion of the regulating member, and the first developer outflow-prevention member prevents the developer removed from the developing roller and the supplying roller from flowing out of the housing.

The sealing film may be a conductive film.

The developing cartridge may further include a second developer outflow-prevention member installed on the housing having an upper portion to contact a lower portion of the first developer outflow-prevention member and a side surface to contact the first portion of the regulating member, and the second developer outflow-prevention member prevents the developer removed from the developing roller and the supplying roller from flowing out of the housing.

The foregoing and/or other aspects of the present general inventive concept may also be achieved by providing a developing cartridge usable with an image forming apparatus, the developing cartridge comprising a housing having a storage unit disposed at a rear side thereof to store developer and a feed path at a lower side thereof having a surface that is inclined downward from a front side of the housing toward the storage unit, wherein unused developer that falls on the feed path near the front side of the housing moves along the feed path to the storage unit due to gravitational force exerted on the developer.

The foregoing and/or other aspects of the present general inventive concept may also be achieved by providing a developing cartridge usable with an image forming apparatus, the developing cartridge comprising a housing having a rear side and a front side, a storage unit disposed in the rear side of the housing to store developer, a developing roller disposed in an opening in the front side of the housing, a supplying roller disposed between the developing roller and the storage unit at the front side of the housing to transfer the developer to the developing roller, and a developer recovering member comprising an inclined surface disposed at a lower side of the housing between the housing and the supplying roller to recover developer into the storage unit.

The foregoing and/or other aspects of the present general inventive concept may also be achieved by providing a developing cartridge usable with an image forming apparatus, the developing cartridge comprising a housing having a rear side and a front side, a storage unit disposed in the rear side of the housing to store developer, a developing roller disposed in an opening in the front side of the housing, a supplying roller disposed between the developing roller and the storage unit at the front side of the housing to transfer the developer to the developing roller, and a developer regulating member disposed at the opening in the housing and having a first portion attached to the housing to extend upward to contact the developing roller and a second portion bent downward with respect to the first portion such that developer removed by the first portion falls on the second portion to slide toward the storage unit.

The foregoing and/or other aspects of the present general inventive concept may also be achieved by providing an electrophotographic image forming apparatus having a developing cartridge, wherein the developing cartridge includes a housing, a storage unit installed inside the housing to store a developer, a developing roller to supply the developer to an electrostatic latent image formed on a photosensitive body, a supplying roller to supply the developer to the developing roller from the storage unit, and a feed surface formed on a lower inner wall of the housing and inclined in a downward direction toward the storage unit so that the developer removed from the developing roller and the supplying roller flows toward the storage unit and is collected therein.

The electrophotographic image forming apparatus may further include a regulating member having a first side being installed on the housing and a second side to regulate a layer of the developer attached to an outer circumference of the developing roller.

The developing cartridge may further include a first developer outflow-prevention member installed at the feed surface having a first side to contact a side surface of the regulating member, and the first developer outflow-prevention member prevents the developer removed from the developing roller and the supplying roller from flowing out of the housing.

The first developer outflow-prevention member may be a sealing film.

The regulating member may include a first portion having a first side installed on the housing and a second side to contact the outer circumference of the developing roller along a lengthwise direction thereof to provide a predetermined pressure thereto, and a second portion bent with respect to the first portion at a predetermined angle to extend in a direction of the feed surface to a predetermined length.

The developing cartridge may further include a first developer outflow-prevention member installed at the feed surface having a first side to contact a side surface of the first portion of the regulating member, and the first developer outflow-prevention member prevents the developer removed from the developing roller and the supplying roller from flowing out of the housing.

The first developer outflow-prevention member may be a sealing film.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a partial cross-sectional view illustrating a conventional developing cartridge of an electrophotographic image forming apparatus;

FIG. 2 is a schematic cross-sectional view illustrating an electrophotographic image forming apparatus according to an embodiment of the present general inventive concept;

FIG. 3 is a cross-sectional view illustrating a developing cartridge of the electrophotographic image forming apparatus of FIG. 2;

FIG. 4 illustrates an operation of recovering a developer in the developing cartridge of FIG. 3; and

FIG. 5 illustrates an operation of recovering a developer in the developing cartridge of FIG. 3.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

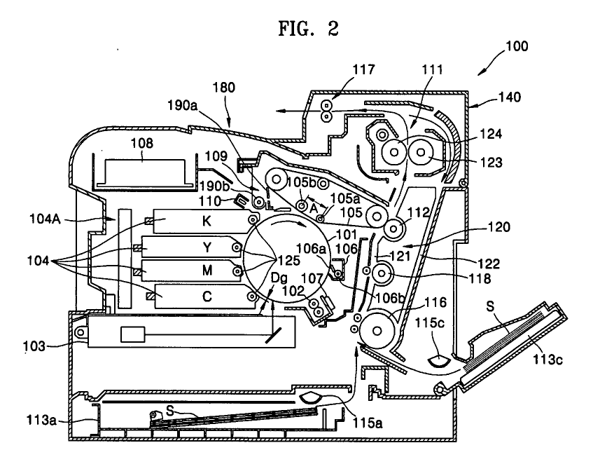

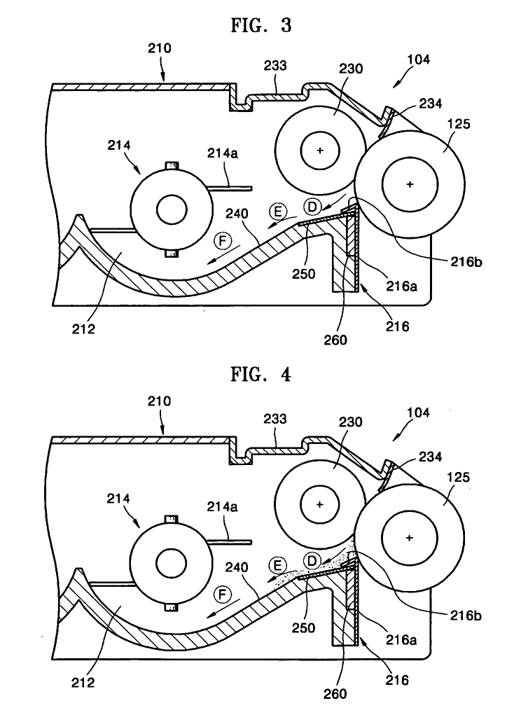

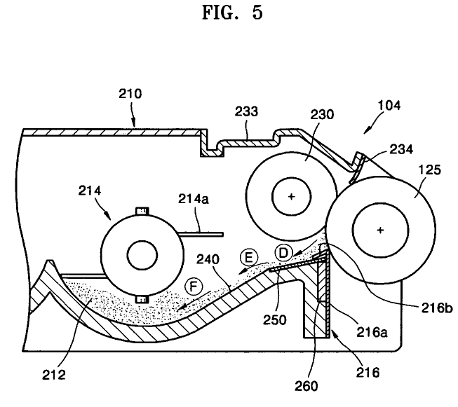

FIG. 2 is a schematic cross-sectional view illustrating an image forming apparatus 100 according to an embodiment of the present general inventive concept, FIG. 3 is a cross-sectional view illustrating a developing cartridge 104 of the image forming apparatus 100 of FIG. 2, and FIGS. 4 and 5 illustrate an operation of the developing cartridge 104 of FIG. 3.

Referring to FIG. 2, the image forming apparatus 100 includes a photosensitive body 101, a charging roller 102, a laser scanning unit (LSU) 103, four developing cartridges 104, and a transfer belt 105, which are installed inside a frame 140.

The photosensitive body 101 is installed in such a manner that a photoconductive material layer is coated on an outer circumference of a cylindrical metallic drum using a method such as deposition or the like, and a portion of the outer circumference is not exposed. The photosensitive body 101 is rotated in a predetermined direction, and an electrostatic latent image, which corresponds to an image to be printed, is formed on the outer circumference of the photosensitive body 101 by light irradiated by the LSU 103 (described below).

The charging roller 102 charges the photosensitive body 101 to a uniform potential. The charging roller 102 is rotated in contact with (or not in contact with) the outer circumference of the photosensitive body 101 to supply a charge so that the outer circumference of the photosensitive body 101 has the uniform potential. A charging bias voltage is applied to the charging roller 102 to charge the outer circumference of the photosensitive body 101 to the uniform potential. A corona charger (not shown) may be used instead of the charging roller 102.

The LSU 103 is installed below the photosensitive body 101 to scan light that corresponds to image information onto the photosensitive body 101, which is charged to the uniform potential, in response to a computer signal to form the electrostatic latent image on the outer circumference of the photosensitive body 101.

Each of the four developing cartridges 104C, 104M, 104Y, and 104K includes a cartridge mounted in the frame 140 to be attached/detached in the frame 140. The four developing cartridges 104C, 104M, 104Y, and 104K may contain solid powder developers (e.g. toner) having four colors including cyan (C), magenta (M), yellow (Y), and black (K). Each of the developing cartridges 104C, 104M, 104Y, and 104K comprises a developing roller 125 to supply the developers to the electrostatic latent image formed on the photosensitive body 101 to form a toner image. The developing cartridges 104C, 104M, 104Y, and 104K can be replaced with new ones when the developers contained therein are exhausted. The structure of the developing cartridges 104C, 104M, 104Y and 104K will now be described in detail.

The developing roller 125 adheres the developer contained in the developing cartridge 104 to an outer circumference thereof to supply the adhered developer to the photosensitive body 101. The developing roller 125 can hold a solid powder developer, and supplies the developer to the electrostatic latent image formed on the photosensitive body 101 to develop the toner image. A developing bias voltage is applied to the developing roller 125 so as to supply the developer from the developing roller 125 to the photosensitive body 101.

The four developing cartridges 104C, 104M, 104Y, and 104K are installed in such a manner that the developing roller 125 is separated from the outer circumference of the photosensitive body 101 by a predetermined developing gap D_{g}. Alternatively, the four developing cartridges 104C, 104M, 104Y, and 104K may be installed such that the developing roller 125 contacts the outer circumference of the photosensitive body 101. A force that directs to the developer from the developing roller 125 to the photosensitive body 101 is generated by an electric field formed between the developing cartridges 104C, 104M, 104Y, and 104K and the photosensitive body 101. The charged developer makes a vibration reciprocating motion in a developing area formed between the developing gaps D_{g} while being fed to the photosensitive body 101, thereby performing a developing operation.

A developing cartridge driving unit 104A to selectively drive the four developing cartridges 104C, 104M, 104Y, and 104K is installed at one side of the four developing cartridges 104C, 104M, 104Y, and 104K.

In the present embodiment, the four developing cartridges 104C, 104M, 104Y, and 104K may be arranged in a sequence of a cyan developing cartridge 104C, a magenta developing cartridge 104M, a yellow developing cartridge 104Y, and a black developing cartridge 104K with respect to an upward direction. Other arrangements of developing cartridges may also be used with the present general inventive concept. Additionally, it should be understood that other combinations of colors may alternatively be used in the developing cartridges of the present general inventive concept. A pre-transfer eraser 110 is disposed above the developing cartridge 104K installed in an uppermost position. A paper feeding unit 120 is installed at a side of the photosensitive body 101 that is opposite to the developing cartridges 104C, 104M, 104Y, and 104K around the photosensitive body 101, to be rotated.

Toner images having the cyan (C), magenta (M), yellow (Y), and black (K) colors, which are sequentially formed on the photosensitive body 101, are sequentially transferred to the transfer belt 105. The toner images are overlapped and transferred to the transfer belt 105 so that a color toner image is formed.

On an inner surface of the transfer belt 105, a plurality of supporting rollers support the transfer belt 105 and rotate the transfer belt 105 in a predetermined direction.

A nip roller 105a is installed on the inner surface of the transfer belt 105 so that the photosensitive body 101 and the transfer belt 105 maintain a predetermined nip A. A first transfer bias voltage is applied to an intermediate transfer roller 105b so that the toner image formed on the photosensitive body 101 is transferred to the transfer belt 105.

The transfer belt 105 is installed to face the photosensitive body 101 in a section between the intermediate transfer roller 105b and the nip roller 105a so that the toner image formed on the outer circumference of the photosensitive body 101 is transferred to the transfer belt 105 from the photosensitive body 101. In other words, the transfer belt 105 is supported by the plurality of supporting rollers, is rotated and transferred along a predetermined track, and the toner image formed on the outer circumference of the photosensitive body 101 is transferred from the photosensitive body 101 as the transfer belt 105 moves along the predetermined track.

A first cleaning unit 106 includes a first blade 106a to contact a surface of the photosensitive body 101 and scratch a waste toner remaining on the surface of the photosensitive body 101 after a transfer operation is performed, and a first transfer unit 106b to feed the waste toner to a waste developer storage unit (not shown).

A second cleaning unit 109 removes a waste toner remaining on the transfer belt 105 after the toner image is transferred onto a sheet(s) of paper S. The second cleaning unit 109 includes a second blade 190a to scratch a waste toner remaining on a surface of the transfer belt 105, and a second transfer unit 190b to feed the waste toner to the waste developer storage unit (not shown).

A transfer roller 112 is installed to face a side of the transfer belt 105 on which the toner image is transferred (i.e., an outer surface thereof). A transfer bias voltage having an opposite polarity to that of the toner image is applied to the transfer roller 112 so that the toner image that is transferred to the transfer belt 105 is transferred onto the sheet(s) of paper S. The toner image is transferred onto the sheet(s) of paper S by an electrostatic force that acts between the transfer belt 105 and the transfer roller 112. The transfer roller 112 is separated from the transfer belt 105 while the color toner image is transferred to the transfer belt 105. Then, once the color toner image is completely transferred to the transfer belt 105, the transfer roller 112 contacts the transfer belt 105 to provide a predetermined pressure to transfer the color toner image onto the sheet(s) of paper S. In addition, the toner image transferred to the outer surface of the transfer belt 105 may be transferred onto the sheet(s) of paper S that pass between the transfer roller 112 and the transfer belt 105 by contact pressure between the transfer belt 105 and the transfer roller 112.

The pre-transfer eraser 110 removes a portion (non-image region) other than a portion of the photosensitive body 101 in which the toner image is formed, before transferring the toner image formed on the photosensitive body 101 to the transfer belt 105. The pre-transfer eraser 110 is installed to improve a transfer efficiency from the photosensitive body 101 to the transfer belt 105.

An erasing lamp 107 removes a charge remaining on the outer circumference of the photosensitive body 101 before a next charging operation. The erasing lamp 107 removes the charge remaining on the surface of the photosensitive body 101 by radiating a predetermined amount of light onto the outer circumference of the photosensitive body 101.

A high voltage power supply 108 supplies voltages to components installed in the image forming apparatus 100 including the developing bias voltage to develop the developer from the developing cartridge 104 to the photosensitive body 101, a developing-prevention bias voltage to prevent the developer from adhering to the photosensitive body 101 from the developing cartridge 104, the first transfer bias voltage to transfer the toner image to the transfer belt 105 from the photosensitive body 101, the second transfer bias voltage to transfer the toner image onto the sheet(s) of paper S from the transfer belt 105, and the charging bias voltage to be supplied to the charging roller 102.

A fusing unit 111 includes a heating roller 123 and a pressing roller 124 that faces the heating roller 123. The fusing unit 111 fuses the toner image on the sheet(s) of paper S by applying heat and pressure to the toner image that is transferred onto the sheet(s) of paper S. The heating roller 123 comprises a heat source to permanently fix the toner image to the sheet(s) of paper S and faces the pressing roller 124 in an axial direction. The pressing roller 124 faces the heating roller 123 and fuses the toner image on the sheet(s) of paper S by applying a high pressure to the sheet(s) of paper S.

A paper discharging roller 117 discharges the sheet(s) of paper S on which a fusing operation is performed by the fusing unit 111, out of the image forming apparatus 100. The sheet(s) of paper S discharged out of the image forming apparatus 100 are stacked on a paper discharging unit 180.

The image forming apparatus 100 further includes a paper feeding cassette 113a disposed below the image forming apparatus 100 on which the sheet(s) of paper S are stacked. The paper feeding cassette 113a is an example of a stacking unit on which the sheet(s) of paper S are stacked. The stacking unit may also include a multi-purpose feeder (MPF) 113c to feed the sheet(s) of paper S. The MPF 113c can be used to feed an OHP paper or a non-standard paper S. The paper feeding cassette 113a includes a knock-up plate on which the sheet(s) of paper S are stacked, and an elastic member to elastically bias the knock-up plate toward a pickup roller 115a that is described below. The sheet(s) of paper S stacked on the knock-up plate are transferred by the pickup roller 115a one by one. A pickup roller 115c transfers the sheet(s) of paper S from the MPF 113c.

The pickup rollers 115a and 115c are installed above the paper feeding cassette 113a and the MPF 113c and feed the sheet(s) of paper S that are stacked thereon to a feed roller 116 that is described below.

The feed roller 116 feeds the sheet(s) of paper S to be transferred from the paper feeding cassette 113a and the MPF 113c by the pickup rollers 115a and 115c, respectively, to the paper feeding unit 120.

The paper feeding unit 120 includes a paper feeding path 121 along which the sheet(s) of paper S are guided between the feed roller 116 and the fusing unit 111, and a duplex path 122 for a duplex printing operation. A registration roller 118 is installed in the paper feeding unit 120. The registration roller 118 registers the sheet(s) of paper S so that the toner image is transferred to a desired portion of the sheet(s) of paper S before the sheet(s) of paper S that have been transferred from the feed roller 116 pass between the transfer belt 105 and the transfer roller 112. The sheet(s) of paper S are transferred between the transfer belt 105 and the transfer roller 112 while the toner image is transferred onto the sheet(s) of paper S. The toner image that is transferred onto the sheet(s) of paper S is fused on the sheet(s) of paper S via the fusing unit 111. The sheet(s) of paper S having the toner image fused thereon are then discharged out of the image forming apparatus 100 by the paper discharging roller 117 onto the paper discharging unit 180.

The paper discharging roller 117 can be rotated in a reverse direction during the duplex printing operation, and the sheet(s) of paper S are transferred along the duplex path 122. The sheet(s) of paper S are then reversed so that an image can be printed on a side of the sheet(s) of paper S on which an image is not printed (i.e., a reverse side). The reversed sheet(s) of paper S are fed via the paper feeding path 121 by the feed roller 116 and the image is printed on the other side of the sheet(s) of paper S.

The developing cartridge 104 of the image forming apparatus 100 according to the present general inventive concept will now be described.

Referring to FIG. 3, the developing cartridge 104 includes a housing 210, a storage unit 212 installed inside the housing 210, the developing roller 125, and a supplying roller 230.

The storage unit 212 is disposed inside the housing 210 to store the developer (e.g., the toner) is therein. An agitator 214 is installed in the storage unit 212.

An agitator film 214a is formed on an outer circumference of the agitator 214. The agitator 214 is rotated in a predetermined direction to supply the developer contained in the storage unit 212 to the supplying roller 230. The agitator film 214a, which may be formed to be longer than necessary to contact an inner wall of the storage unit 212, contacts the inner wall of the storage unit 212 when rotating and supplies the developer to the supplying roller 230. The agitator film 214a may be a conductive film.

A seal bracket 233 is installed at a front upper part of the housing 210 to cover the developing roller 125 and the supplying roller 230 and to prevent outflow of the developer from the housing 210. A seal film 234 is attached to one side of the seal bracket 233. The seal film 234 prevents the developer between the developing roller 125 and the supplying roller 230 from flowing out of the housing 210 and prevents any foreign substances from flowing into the developing cartridge 104.

The developing roller 125 is installed in front of the housing 210. The photosensitive body 101 (FIG. 2) on which the electrostatic latent image is formed is disposed at one side of the developing roller 125 to contact (or be separated from) the developing roller 125. The developing roller 125 develops the electrostatic latent image formed on the photosensitive body 101 by supplying the developer to the photosensitive body 101.

The supplying roller 230 is installed at the other side of the developing roller 125 to contact (or be separated from) the developing roller 125. The supplying roller 230 is rotated in the same direction as the developing roller 125 (or in the reverse direction) and supplies the developer to the outer circumference of the developing roller 125. Alternatively, the supplying roller 230 supplies the developer to the surface of the developing roller 125 by pressing the developer on the surface of the developing roller 125s to contact the developing roller 125. The supplying roller 230 also cleans the developing roller 125 by removing residual developer off of the surface of the developing roller 125.

A feed surface 240 is formed on a lower inner wall of the housing 210. The feed surface 240 is inclined in a downward direction toward the storage unit 212 so that the developer removed from the developing roller 125 and the supplying roller 230 flows toward the storage unit 212 and is collected therein. That is, the feed surface 240 is inclined so that the developer that is removed from the developer roller 125 and the supplying roller 230 flows toward the storage unit 212 along a first path D, a second path E, and a third path F path due to gravitational force.

One side of a regulating member 216 is installed in the housing 210 and the other side thereof regulates a layer of the developer on the surface of the developing roller 125. That is, the regulating member 216 regulates a thickness of the layer of developer attached to the outer circumference of the developing roller 125. The regulating member 216 removes excessive developer that is attached to the outer circumference of the developing roller 125.

In the developing cartridge 104 according to the present general inventive concept, a center of the supplying roller 230 is disposed in a higher position than a center of the developing roller 125, and the regulating member 216 may be disposed in a lower position than the center of the developing roller 125 so that the developer removed from the developing roller 125 by the regulating member 216 flows toward the feed surface 240.

A first developer outflow-prevention member 250 is installed at one side of the feed surface 240. One side of the first developer outflow-prevention member 250 contacts a side surface of the regulating member 216. The first developer outflow-prevention member 250 prevents the developer removed from the developing roller 125 and the supplying roller 230 from flowing out of the developing cartridge 104 and prevents foreign substances outside of the developing cartridge 104 from flowing into the developing cartridge 104. The first developer outflow-prevention member 250 may be a sealing film. In addition, the sealing film may be a conductive film or an elastic film having a predetermined thickness, for example, a polyetyleneterephthalate (PET) film.

A second developer outflow-prevention member 260 is installed on the side surface of the regulating member 216 and below the first developer outflow-prevention member 250. That is, the second developer outflow-prevention member 260 is installed at one side of the housing 210 so that its upper portion contacts a lower portion of the first developer outflow-prevention member 250 and its side surface contacts the side surface of the regulating member 216. The second developer outflow-prevention member 260 prevents the developer removed from the developing roller 125 and the supplying roller 230 from flowing out of the developing cartridge 104 and prevents foreign substances outside of the developing cartridge 104 from flowing into the developing cartridge 104. The second developer outflow-prevention member 260 may be a sealing member.

In addition, the regulating member 216 may include a first portion 216a installed on the housing 210 and a second portion 216b bent with respect to the first portion 216a. One side of the first portion 216a is installed with the housing 210 and the other side of the first portion 216a contacts the outer circumference of the developing roller 125 along a lengthwise direction thereof and applies a predetermined pressure. The second portion 216b of the regulating member 216 is bent with respect to the first portion 216a at a predetermined angle and extends in a direction of the feed surface 240 to a predetermined length.

In this case, one end of the first developer outflow-prevention member 250 contacts the side surface of the first portion 216a of the regulating member 216, and an upper portion of the second developer outflow-prevention member 260 contacts a lower portion of the first developer outflow-prevention member 250. The side surface of the second developer outflow-prevention member 260 contacts the first portion 216a. That is, a portion of the first developer outflow-prevention member 250 that contacts the side surface of the first portion 216a is longer in a direction of the developing roller 125 than an end of the second portion 216b of the regulating member 216. Thus, the second portion 216b may guide the developer so that the developer does not flow out of the developing cartridge 104.

According to the above-described structure, the developer removed from the developing roller 125 by the regulating member 216 and the developer that is not attached to the outer circumference of the developing roller 125 from the supplying roller 230 flows toward the feed surface 240, slides along the feed surface 240 due to the gravitational force, and is transferred back into the storage unit 212. That is, the developer is fed to the storage unit 212 along the first, second, and third paths D, E, and F.

Operation of the developing cartridge 104 and the image forming apparatus 100 having the same according to the present general inventive concept will now be described.

Color image information is created by mixing information that corresponds to colors, such as cyan (C), magenta (M), yellow (Y), and black (K). In the present embodiment, a toner image of each color is overlapped on the transfer belt 105, is transferred onto the sheet(s) of paper S and is fused thereon in a sequential order of cyan (C), magenta (M), yellow (Y), and black (K), thereby forming a color image. Other orders and/or colors may also be used with the present general inventive concept.

The outer circumference of the photosensitive body 101 is charged by the charging roller 102 to the uniform potential. When a light signal corresponding to the image information of cyan (C) color is irradiated onto the photosensitive body 101 by the LSU 103, a resistance of an irradiated portion is reduced and a charge attached to the outer circumference of the photosensitive body 101 is discharged. Thus, a potential difference between the irradiated portion and an unirradiated portion is formed. As such, the electrostatic latent image is formed on the outer circumference of the photosensitive body 101.

When the photosensitive body 101 is rotated and the electrostatic latent image is close to the cyan developing cartridge 104C, the developing roller 125 of the cyan developing cartridge 104C starts to rotate. The developing bias voltage is applied to the developing roller 125 of the cyan developing cartridge 104C from the high voltage power supply 108. The developing-prevention bias voltage is applied to the developing roller 125 of the other developing cartridges 104M, 104Y, and 104K. As a result, only the developer having the cyan (C) color is attached to the electrostatic latent image formed on the outer circumference of the photosensitive body 101 across the developing gap Dg and the toner image having the cyan (C) color is formed.

When the toner image having the cyan (C) color is close to the transfer belt 105 due to rotation of the photosensitive body 101, the toner image is transferred to the transfer belt 105 by the first transfer bias voltage or a contact pressure between the photosensitive body 101 and the transfer belt 105.

After the toner image having the cyan (C) color is completely transferred to the transfer belt 105, toner images having each of the colors magenta (M), yellow (Y), and black (K) are overlapped and transferred to the transfer belt 105 through the procedure described above. In this case, the developing cartridge driving unit 104A drives each of the developing cartridges 104C, 104M, 104Y, and 104K so that the developing operation is performed through the procedure described above.

During the operation of the developing cartridge 104, the transfer roller 112 is separated from the transfer belt 105. When all of the four-color toner images are overlapped and transferred to the transfer belt 105 and the color toner image is formed on the transfer belt 105, the transfer roller 112 contacts the transfer belt 105 so that the color toner image is transferred onto the sheet(s) of paper S.

The sheet(s) of paper S are supplied from the paper feeding cassette 113a or the MPF 113c so that a front end of each of the sheet(s) of paper S reaches a position where the transfer belt 105 and the transfer roller 112 contact each other, when a front end of the color toner image formed on the transfer belt 105 reaches the position where the transfer belt 105 and the transfer roller 112 contact each other. When the sheet(s) of paper S pass between the transfer belt 105 and the transfer roller 112, the color toner image is transferred onto the sheet(s) of paper S by the second transfer bias voltage and is then fixed by the fusing unit 111 on the sheet(s) of paper S by heat and pressure. The sheet(s) of paper S having the color image thereon are then discharged.

For a next printing operation, the first and second cleaning units 106 and 109 remove the waste developer remaining on the photosensitive body 101 and the transfer belt 105, respectively, and the erasing lamp 107 radiates light onto the photosensitive body 101 to remove the charges remaining on the photosensitive body 101.

The operation of the developing cartridge 104 to develop the electrostatic latent image formed on the outer circumference of the photosensitive body 101 will now be described.

The developer contained in the storage unit 212 is supplied to the supplying roller 230 by the agitator 214 and is attached to the outer circumference of the developing roller 125 by the supplying roller 230. When the developer that is attached to the outer circumference of the developing roller 125 is supplied to the photosensitive body 101, the electrostatic latent image formed on the photosensitive body 101 can be visualized.

The developer that is not attached to the surface of the developing roller 125 from the supplying roller 230 (i.e., the developer remaining on the supplying roller 230) during the procedure described above, and the developer that is removed from the surface of the developing roller 125 by the regulating member 216 are fed to the storage unit 212 along the first, second, and third paths in a sequential order of D→E→F as illustrated in FIGS. 4 and 5. In this case, the developer that is removed from the surface of the developing roller 125 by the regulating member 216 flows toward the feed surface 240 along the second portion 216b of the regulating member 216. That is, the second portion 216b guides the developer not to flow out of the developing cartridge 104.

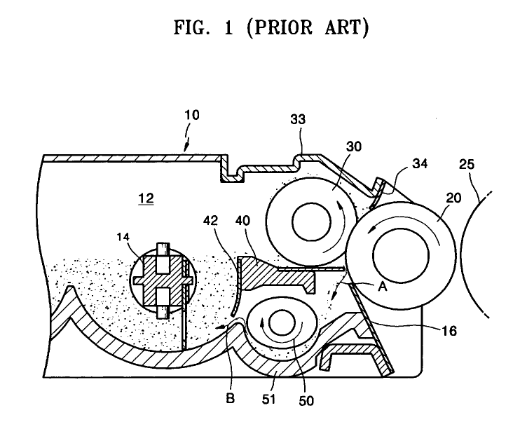

According to the various embodiments of the present general inventive concept, the developer that is detached and/or removed from the supplying roller 230 and the developing roller 125 can be recovered without using an additional recovering member that requires space movement, such as the recovering roller 50 of the conventional developing cartridge illustrated in FIG. 1.

As described above, in a developing cartridge and an electrophotographic image forming apparatus having the same according to various embodiments of the present general inventive concept, since an additional recovering member is not required unlike the conventional developing cartridge (FIG. 1), a structure of the developing cartridge can be simplified. Thus, a space in which to install the additional recovering member can be omitted such that the developing cartridge and the image forming apparatus can be made compact. Furthermore, a driving source to drive the additional recovering member is not needed such that costs are reduced and the image forming apparatus can be made more compact.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A developing cartridge usable with an electrophotographic image forming apparatus, the developing cartridge comprising:
a housing;
a storage unit installed inside the housing to store a developer;
a developing roller to supply the developer to an electrostatic latent image formed on a photosensitive body; and
a supplying roller to supply the developer to the developing roller from the storage unit,
wherein the housing comprises a feed surface formed on a lower inner wall thereof and inclined in a downward direction toward the storage unit so that the developer removed from the developing roller and the supplying roller flows toward the storage unit and collects therein.

2. The developing cartridge of claim 1, further comprising:
a regulating member having a first side being installed on the housing and a second side to regulate a layer of the developer attached to an outer circumference of the developing roller.

3. The developing cartridge of claim 2, wherein a center of the supplying roller is installed at a higher position than a center of the developing roller, and the regulating member is installed at a lower position than the center of the developing roller so that the developer removed from the developing roller by the regulating member flows toward the feed surface.

4. The developing cartridge of claim 3, further comprising:
a first developer outflow-prevention member installed at the feed surface and having a first side to contact a side surface of the regulating member, and the first developer outflow-prevention member prevents the developer removed from the developing roller and the supplying roller from flowing out of the housing.

5. The developing cartridge of claim 4, wherein the first developer outflow-prevention member comprises a sealing film.

6. The developing cartridge of claim 5, wherein the sealing film comprises a conductive film.

7. The developing cartridge of claim 4, further comprising:
a second developer outflow-prevention member installed in the housing and having an upper portion to contact a lower portion of the first developer outflow-prevention member and a side surface to contact the regulating member, and the second developer outflow-prevention member prevents the developer removed from the developing roller and the supplying roller from flowing out of the housing.

8. The developing cartridge of claim 7, wherein the second developer outflow-prevention member comprises a sealing member.

9. The developing cartridge of claim 2, wherein the regulating member comprises:
a first portion having a first side installed on the housing and a second side to contact the outer circumference of the developing roller along a lengthwise direction thereof to provide a predetermined pressure thereon; and
a second portion bent with respect to the first portion at a predetermined angle to extend in a direction of the feed surface to a predetermined length.

10. The developing cartridge of claim 9, wherein a center of the supplying roller is installed at a higher position than a center of the developing roller, and the regulating member is installed at a lower position than the center of the developing roller so that the developer that is removed from the developing roller by the regulating member flows toward the feed surface.

11. The developing cartridge of claim 10, further comprising:
a first developer outflow-prevention member installed at the feed surface and having a first side to contact a side surface of the first portion of the regulating member, and the first developer outflow-prevention member prevents the developer removed from the developing roller and the supplying roller from flowing out of the housing.

12. The developing cartridge of claim 11, wherein the sealing film comprises a conductive film.

13. The developing cartridge of claim 12, further comprising:
a second developer outflow-prevention member installed in the housing and having an upper portion to contact a lower portion of the first developer outflow-prevention member and a side surface to contact the first portion of the regulating member, and the second developer outflow-prevention member prevents the developer removed from the developing roller and the supplying roller from flowing out of the housing.

14. An electrophotographic image forming apparatus, comprising:
a developing cartridge, comprising:
a housing;
a storage unit installed inside the housing to store a developer;
a developing roller to supply the developer to an electrostatic latent image formed on a photosensitive body;
a supplying roller to supply the developer to the developing roller from the storage unit; and
a feed surface formed on a lower inner wall of the housing and inclined in a downward direction toward the storage unit so that the developer removed from the developing roller and the supplying roller flows toward the storage unit and collects therein.

15. The electrophotographic image forming apparatus of claim 14, further comprising:
a regulating member having a first side being installed on the housing and a second side to regulate a layer of the developer attached to an outer circumference of the developing roller.

16. The electrophotographic image forming apparatus of claim 15, further comprising:
a first developer outflow-prevention member installed at the feed surface and having a first side to contact a side surface of the regulating member, and the first developer outflow-prevention member prevents the developer removed from the developing roller and the supplying roller from flowing out of the housing.

17. The electrophotographic image forming apparatus of claim 16, wherein the first developer outflow-prevention member comprises a sealing film.

18. The electrophotographic image forming apparatus of claim 15, wherein the regulating member comprises:
a first portion having a first side installed on the housing and a second side to contact the outer circumference of the developing roller along a lengthwise direction thereof to provide a predetermined pressure thereto; and
a second portion bent with respect to the first portion at a predetermined angle and to extend in a direction of the feed surface to a predetermined length.

19. The electrophotographic image forming apparatus of claim 18, further comprising:
a first developer outflow-prevention member installed at the feed surface and having a first side to contact a side surface of the first portion of the regulating member, and the first developer outflow-prevention member prevents the developer removed from the developing roller and the supplying roller from flowing out of the housing.

20. The electrophotographic image forming apparatus of claim 19, wherein the first developer outflow-prevention member comprises a sealing film.
